(19) United States
(12) Patent Application Publication
(10) Pub. No.: US 2018/0346621 A1
(43) Pub. Date: Dec. 6, 2018

(54) POLYOLEFIN GASKETS FOR CLOSURES

(71) Applicant: BASELL POLIOLEFINE ITALIA S.R.L., Milano (IT)

(72) Inventors: ROBERTA MARCHINI, FERRARA (IT); STEFANO SPATARO, FERRARA (IT); STEFANO PASQUALI, FERRARA (IT); GIANLUCA MUSACCHI, FERRARA (IT)

(73) Assignee: BASELL POLIOLEFINE ITALIA S.R.L., MILANO (IT)

(21) Appl. No.: 15/574,107

(22) PCT Filed: May 24, 2016
(86) PCT No.: PCT/EP2016/061648

§ 371 Date: Nov. 14, 2017

(30) Foreign Application Priority Data
May 26, 2015 (EP) 15169240.7

(51) Int. Cl. C08F 210/08; C08F 210/06; C09K 3/10; B29C 47/00; B29C 47/02; B65D 41/04

(52) U.S. Cl. CPC C08F 210/08; C08F 210/06; C09K 3/10; B29K 2023/16; B29C 47/022; B65D 41/0442; C08F 2800/20; B29C 47/0004

(57) ABSTRACT

The present disclosure provides a gasket for closures made from or containing a polyolefin composition (I) made from or containing
A) from about 25 to about 62% by weight of a copolymer of butene-1 with ethylene having a copolymerized ethylene content of up to about 18% by mole and without a melting peak detectable at the DSC at the second heating scan;
B) from about 38 to about 75% by weight of (i) a propylene homopolymer, or (ii) a propylene copolymer, or (iii) a mixture of two or more of (i) and (ii), having a melting temperature Tₘ, measured by DSC at the second heating scan, of from about 130° C. to about 165° C.;

wherein the amounts of A) and B) are referred to the total weight of A)+B) and the DSC second heating scan is carried out with a heating rate of about 10° C. per minute.

### FIELD OF THE INVENTION

In general, the present disclosure relates to the field of chemistry. More specifically, the present disclosure relates to polymer chemistry. In particular, the present disclosure relates to a gasket for closures, including twist closures, made from or containing a polyolefin composition having low values of hardness in combination with good tensile and elastic properties, free of low molecular weight softening additives.

### BACKGROUND OF THE INVENTION

Gaskets can be used as sealing elements in a very wide range of closure types.

In some applications, gaskets are used in twist closures for containers like jars and bottles. Some of those jars and glasses are made of glass or plastic materials.

In some instances, the twist closures are in the form of caps of circular shape and host the gasket on the inner surface of the caps with the gasket facing the opening in the threaded circular neck of the container. In some instances, the caps are made of metal or plastics.

The gasket can be used to achieve a tight seal on the rim of the opening of the container.

By twisting (rotating) the closure, it is possible to close and open the container.

In some application, Press-on/Twist-off® caps are pressed on the container to close by deforming elastically the gasket against the threading elements of the neck of the container and then twisting to open.

A gasket should be soft and elastic enough to ensure a tight seal even after long use.

For food preservation and pharmaceutical use, liners should be nontoxic, not release soluble components, and occasionally sterilizable.

### SUMMARY OF THE INVENTION

In a general embodiment, the present disclosure provides a gasket for closures made from or containing:
(a) a polyolefin composition (I) made from or containing:
   A) from about 25 to about 62% by weight, based upon the total weight of the polyolefin composition, alternatively from about 30 to about 61% by weight, of a copolymer of butene-1 with ethylene having a copolymerized ethylene content of up to about 18% by mole, based upon the molar composition of the copolymer and without a melting peak detectable at the DSC at the second heating scan;
   B) from about 38 to about 75% by weight, based upon the total weight of the polyolefin composition, alternatively from about 39 to about 70% by weight, of (i) a propylene homopolymer, or (ii) a propylene copolymer, or (iii) a mixture of two or more of (i) and (ii), having a melting temperature Tₘ, measured by DSC at the second heating scan, of from about 130° C. to about 165° C., alternatively from about 131 to about 165° C., alternatively from about 131 to about 160° C.;
wherein the amounts of A) and B) are referred to the total weight of A)+B) and the DSC second heating scan is carried out with a heating rate of about 10° C. per minute.

In some embodiments, the polyolefin composition (I) has high softness (Shore A about 90), good tensile properties (elongation at break in the range of about 1000% to about 1300%) and elastic properties (compression set at 23° C. of about 50%).

### DETAILED DESCRIPTION OF THE INVENTION

In some embodiments, component B) is a propylene copolymer (i) or a mixture (iii) of a propylene homopolymer and a propylene copolymer.

In some embodiments, the polyolefin composition (I) has a melting temperature Tₘ which is about the melting temperature Tₘ of the propylene homopolymer or copolymer component B). In some embodiments, the melting temperature is the range from about 130° C. to about 165° C., alternatively from about 132 to about 165° C., alternatively from about 130 to about 160° C.

In some embodiments, a single melting peak is detected in the second DSC scan of the propylene homopolymer or copolymer component B) and in the second DSC scan of the polyolefin composition (I) in the temperature range.

In some embodiments, more than one peak be detected. In those instances, the temperature of the most intense melting peak in the temperature range is considered the Tₘ value for both component B) and the polyolefin composition made from or containing A) and B).

In some embodiments, the fusion enthalpy ΔH_{fus} value for the polyolefin composition (I) is determined by the area of the melting peak or the total area of melting peaks (if more than one) in the DSC temperature range from about 130° to about 160° C.

In some embodiments, ΔH_{fus} values for the polyolefin composition (I) are from about 30 to about 55 J/g.

In some embodiments, values of MIE for the composition (I) are from about 0.5 to about 8 g/10 min., where MIE is the melt flow index at 190° C. with a load of 2.16 kg, determined according to ISO 1133.

In some embodiments, Shore A values for the composition (I) are from about 90 to about 95.

In some embodiments, the composition (I) has Shore D values from about 20 to about 45, alternatively from about 23 to about 40.

In some embodiments, compression set values for the composition (I) are from about 45 to about 55% at 23° C.; alternatively, from about 65 to about 80% at 70° C.

In some embodiments, the butene-1 copolymer component A), immediately after being melted and cooled, does not show a melting peak at the second heating scan. In some embodiments, the butene-1 copolymer is crystallizable which is evidenced by after about 10 days, the polymer shows a measurable melting point and a melting enthalpy measured by DSC. The butene-1 copolymer shows no melting temperature attributable to polybutene-1 crystallinity (TmII)_{DSC}, measured after cancelling the butene-1 copolymer's thermal history, according to the DSC method described herein.

In some embodiments, the butene-1 copolymer component A) has at least one of the following additional features:
MIE of from about 0.5 to about 3 g/10 min.;
a lower limit of the copolymerized ethylene content of about 12% by mole, based upon the molar composition of the copolymer;
a Shore A value equal to or lower than about 80, alternatively equal to or lower than about 70, alternatively from about 80 to about 40, or alternatively from about 70 to about 40;
a Shore D value equal to or lower than about 20, alternatively from about 20 to about 5, alternatively lower than about 20, alternatively from lower than about 20 to about 5;
a Mw/Mn value, where Mw is the weight average molar mass and Mn is the number average molar mass, both measured by GPC, equal to or lower than about 3, alternatively from about 3 to about 1.5.
a tension set of less than about 30% at 100% of deformation at 23° C. (ISO 2285), alternatively equal to or less than about 20%, wherein the lower limit is about 5;
a percentage of butene-1 units in form of isotactic pentads (mmmm %) greater than about 80%, alternatively equal to or greater than about 85%, alternatively equal to or greater than about 90%, wherein the upper limit is about 99%;
tensile stress at break, measured according to ISO 527, of from about 3 MPa to about 20 MPa, alternatively from about 4 MPa to about 13 MPa;
tensile elongation at break, measured according to ISO 527, of from about 550% to about 1000%; alternatively from about 700% to about 1000%;
intrinsic viscosity (I.V.) equal to or higher than about 1 dl/g; alternatively equal to or higher than about 1.5 dl/g, wherein the upper limit is about 3 dl/g;
crystallinity of less than about 30% measured via X-ray, alternatively less than about 20%;
density of about 0.895 g/cm³ or less, alternatively about 0.875 g/cm³ or less; wherein the lower limit is about 0.86 g/cm³; and
content of xylene insoluble fraction at 0° C. of less than about 15% by weight, based upon the total weight of the butene-1 copolymer, wherein the lower limit is about 0%.

In some embodiments, the butene-1 copolymer component A) is obtained by polymerizing the monomer(s) in the presence of a metallocene catalyst system obtainable by contacting:
a stereorigid metallocene compound;
an alumoxane or a compound capable of forming an alkyl metallocene cation; and, optionally,
an organo aluminum compound.

In some embodiments, the stereorigid metallocene compound belongs to the following formula (I):

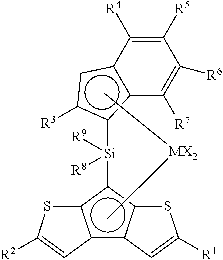

wherein:
M is an atom of a transition metal selected from those belonging to group 4; alternatively M is zirconium; X, equal to or different from each other, is a hydrogen atom, a halogen atom, a R, OR, OR′O, OSO₂CF₃, OCOR, SR, NR₂ or PR₂ group wherein R is a linear or branched, saturated or unsaturated C₁-C₂₀-alkyl, C₃-C₂₀-cycloalkyl, C₆-C₂₀-aryl, C₇-C₂₀-alkylaryl or C₇-C₂₀-arylalkyl radical, optionally containing heteroatoms belonging to groups 13-17 of the Periodic Table of the Elements; and R′ is a C₁-C₂₀-alkylidene, C₆-C₂₀-arylidene, C₇-C₂₀-alkylarylidene, or C₇-C₂₀-arylalkylidene radical; alternatively X is a hydrogen atom, a halogen atom, a OR′O or R group; alternatively X is chlorine or a methyl radical;
R¹, R², R⁵, R⁶, R⁷, R⁸ and R⁹, equal to or different from each other, are hydrogen atoms, or linear or branched, saturated or unsaturated C₁-C₂₀-alkyl, C₃-C₂₀-cycloalkyl, C₆-C₂₀-aryl, C₇-C₂₀-alkylaryl or C₇-C₂₀-arylalkyl radicals, optionally containing heteroatoms belonging to groups 13-17 of the Periodic Table of the Elements; or R⁵ and R⁶, and/or R⁸ and R⁹ can optionally form a saturated or unsaturated, 5 or 6 membered rings, the ring can bear C₁-C₂₀ alkyl radicals as substituents; providing that at least one of R⁶ or R⁷ is a linear or branched, saturated or unsaturated C₁-C₂₀-alkyl radical, optionally containing heteroatoms belonging to groups 13-17 of the Periodic Table of the Elements; alternatively a C₁-C₁₀-alkyl radical;
R³ and R⁴, equal to or different from each other, are linear or branched, saturated or unsaturated C₁-C₂₀-alkyl radicals, optionally containing heteroatoms belonging to groups 13-17 of the Periodic Table of the Elements; alternatively R³ and R⁴ equal to or different from each other are C₁-C₁₀-alkyl radicals; alternatively R³ is a methyl, or ethyl radical; and R⁴ is a methyl, ethyl or isopropyl radical.

In some embodiments, the compounds of formula (I) have formula (Ia):

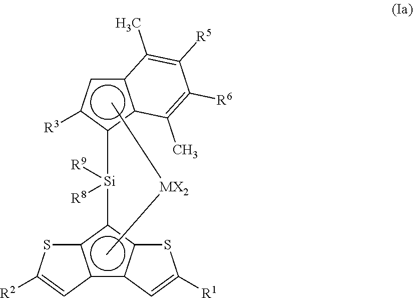

### Wherein:

M, X, R¹, R², R⁵, R⁶, R⁸ and R⁹ have been described above; R³ is a linear or branched, saturated or unsaturated C₁-C₂₀-alkyl radical, optionally containing heteroatoms belonging to groups 13-17 of the Periodic Table of the Elements; alternatively R³ is a C₁-C₁₀-alkyl radical; alternatively R³ is a methyl, or ethyl radical.

In some embodiments, the metallocene compounds are selected from the group consisting of dimethylsilanediyl {(1-(2,4,7-trimethylindenyl)-7-(2,5-dimethyl-cyclopenta[1,2-b:4,3-b′]-dithiophene)}Zirconium dichloride and dimethylsilanediyl {(1-(2,4,7-trimethylindenyl)-7-(2,5-dimethyl-cyclopenta[1,2-b:4,3-b′]-dithiophene)}Zirconium dimethyl.

In some embodiments, the alumoxanes are selected from the group consisting of methylalumoxane (MAO), tetra-(isobutyl)alumoxane (TIBAO), tetra-(2,4,4-trimethyl-pentyl)alumoxane (TIOAO), tetra-(2,3-dimethylbutyl)alumoxane (TDMBAO) and tetra-(2,3,3-trimethylbutyl)alumoxane (TTMBAO).

In some embodiments, the alkylmetallocene cation is prepared from compounds of formula D⁺E⁻, wherein D⁺ is a Brønsted acid, able to donate a proton and to react irreversibly with a substituent X of the metallocene of formula (I) and E⁻ is a compatible anion, which is able to stabilize the active catalytic species originating from the reaction of the two compounds, and which can be removed by an olefinic monomer. Alternatively, the anion E⁻ is made from or containing one or more boron atoms.

In some embodiments, the organo aluminum compound is selected from the group consisting of trimethylaluminum (TMA), triisobutylaluminium (TIBAL), tris(2,4,4-trimethyl-pentyl)aluminum (TIOA), tris(2,3-dimethylbutyl)aluminium (TDMBA) and tris(2,3,3-trimethylbutyl)aluminum (TTMBA).

In some embodiments, the catalyst system and the polymerization processes employing the catalyst system are as disclosed in Patent Cooperation Treaty Publication Nos. WO2004099269 and WO2009000637, incorporated herein by reference.

In some embodiments, the polymerization process for the preparation of the butene-1 copolymer component A) is selected from the group consisting of a slurry polymerization using as diluent a liquid inert hydrocarbon and a solution polymerization. In some embodiments, the solution polymerization uses liquid butene-1 as a reaction medium. In some embodiments, the polymerization process is carried out in the gas-phase, operating in one or more fluidized bed or mechanically agitated reactors.

In some embodiments, the polymerization temperature is from about −100° C. to about 200° C., alternatively from about 20° C. to about 120° C., alternatively from about 40° C. to about 90° C., alternatively from about 50° C. to about 80° C.

In some embodiments, the polymerization pressure is between about 0.5 and about 100 bar.

In some embodiments, the polymerization is carried out in one or more reactors that work under same or different reaction conditions such as concentration of molecular weight regulator, comonomer concentration, temperature, pressure etc.

In some embodiments, the propylene homopolymer or copolymer component B) is a semicrystalline polymer, as demonstrated by the melting point values, and has a stereoregularity of isotactic type.

In some embodiments, the propylene homopolymer or copolymer component B) has a solubility in xylene at room temperature (about 25° C.) equal to or lower than about 25% by weight, the lower limit being about 0.5% by weight.

In some embodiments, the propylene homopolymer or copolymer component B) has MFRL values from about 0.5 to about 9 g/10 min, alternatively from about 1 to about 8 g/10 min., where MFRL is the melt flow index at 230° C. with a load of 2.16 kg, determined according to ISO 1133.

In some embodiments, copolymers B) are copolymers of propylene with one or more comonomers selected from ethylene, C₄-C₁₀ alpha-olefins and their combinations.

In the present description, the term “copolymer” includes polymers containing more than one kind of comonomers.

In some embodiments, the amounts of comonomers in B) are from about 1 to about 15% by weight, alternatively from about 2 to about 10% by weight, based upon the total weight of the copolymer.

In some embodiments, the C₄-C₁₀ alpha-olefins are selected from olefins having formula CH₂═CHR wherein R is an alkyl radical, linear or branched, or an aryl radical, having from 2 to 8 carbon atoms.

In some embodiments, the C₄-C₁₀ alpha-olefins are selected from the group consisting of butene-1, pentene-1,4-methylpentene-1, hexene-1 and octene-1.

In some embodiments, the comonomers in the propylene copolymer B) are selected from the group consisting of ethylene, butene-1 and hexene-1.

In some embodiments, the propylene homopolymer or copolymer component B) is prepared by using a Ziegler-Natta catalyst or a metallocene-based catalyst system in the polymerization process.

In some embodiments, a Ziegler-Natta catalyst is made from or contains the product of the reaction of an organometallic compound of group 1, 2 or 13 of the Periodic Table of elements with a transition metal compound of groups 4 to 10 of the Periodic Table of Elements (new notation). In some embodiments, the transition metal compound is selected among compounds of Ti, V, Zr, Cr and Hf. In some embodiments, the transition metal compound is supported on MgCl₂.

In some embodiments, the catalysts are made from or contain the product of the reaction of the organometallic compound of group 1, 2 or 13 of the Periodic Table of elements, with a solid catalyst component made from or containing a Ti compound and an electron donor compound supported on MgCl₂.

In some embodiments, the organometallic compounds are aluminum alkyl compounds.

In some embodiments, the Ziegler-Natta catalysts are made from or contain the product of reaction of:
1) a solid catalyst component made from or containing a Ti compound and an electron donor (internal electron-donor) supported on MgCl₂;
2) an aluminum alkyl compound (cocatalyst); and, optionally,
3) an electron-donor compound (external electron-donor).

In some embodiments, the solid catalyst component (1) contains, as an electron-donor, a compound selected from the group consisting of ethers, ketones, lactones, compounds containing N, P and/or S atoms, and mono- and dicarboxylic acid esters.

In some embodiments, the catalyst are the catalysts described in U.S. Pat. No. 4,399,054 and European Patent No. 45977, incorporated herein by reference.

In some embodiments, the electron-donor compounds are selected from the group consisting of phthalic acid esters and succinic acid esters. In some embodiments, the electron-donor compound is diisobutyl phthalate.

In some embodiments, the electron-donors are the 1,3-diethers, including those 1,3-diethers described in European Patent Application Nos. EP-A-361 493 and 728769, incorporated herein by reference.

In some embodiments, cocatalysts (2) are trialkyl aluminum compounds. In some embodiments, the cocatalysts (2) are selected from the group consisting of Al-triethyl, Al-triisobutyl and Al-tri-n-butyl.

In some embodiments, the electron-donor compounds (3) that used as external electron-donors (added to the Al-alkyl compound) are made from or contain aromatic acid esters, heterocyclic compounds, and silicon compounds containing at least one Si—OR bond (where R is a hydrocarbon radical). In some embodiments, the aromatic acid esters are alkylic benzoates. In some embodiments, the heterocyclic compounds are selected from the group consisting of 2,2,6,6-tetramethylpiperidine and 2,6-diisopropylpiperidine.

In some embodiments, the silicon compounds have the formula R¹ₐR_{b}²Si(OR³)_{c}, where a and b are integer numbers from 0 to 2, c is an integer from 1 to 3 and the sum (a+b+c) is 4; R¹, R² and R³ are alkyl, cycloalkyl or aryl radicals with 1-18 carbon atoms optionally containing heteroatoms.

In some embodiments, the silicon compounds are selected from the group consisting of (tert-butyl)₂Si(OCH₃)₂, (cyclohexyl)(methyl)Si (OCH₃)₂, (phenyl)₂Si(OCH₃)₂ and (cyclopentyl)₂Si(OCH₃)₂.

In some embodiments, the previously-described 1,3-diethers are used as external donors. In some embodiments, when the internal donor is a 1,3-diether, the external donor is omitted.

In some embodiments, the catalyst is precontacted with small quantities of olefin (prepolymerization), maintained in suspension in a hydrocarbon solvent, and used in polymerization processes at temperatures from about room temperature to about 60° C., to produce a quantity of polymer from 0.5 to 3 times the weight of the catalyst.

In some embodiments, the operation occurs in liquid monomer, to produce a quantity of polymer up to 1000 times the weight of the catalyst.

In some embodiments, the polymerization process is carried out in the presence of the catalysts operating in liquid phase, in the presence or not of inert diluent, or in gas phase, or by mixed liquid-gas techniques. In some embodiments, the polymerization process is continuous. In other embodiments, the process is batch.

In some embodiments, the temperature is from about 20 to about 100° C. In the some embodiments, the pressure is atmospheric or higher.

In some embodiments, the regulation of the molecular weight is carried out by using regulators. In some embodiments, the regulator is hydrogen.

In some embodiments, the metallocene-based catalyst systems are selected from the catalyst systems disclosed in U.S. Patent Application Publication No. 20060020096 and Patent Cooperation Treaty Publication No. WO98040419, incorporated herein by reference.

In some embodiments, the polymerization conditions for preparing the homopolymer or copolymer component B) with metallocene-based catalyst systems are similar to those conditions used with Ziegler-Natta catalysts.

The polyolefin composition (I) can also contain additives, such as antioxidants, light stabilizers, heat stabilizers, colorants and fillers.

The polyolefin composition (I) can also contain additional polyolefins. In some embodiments, the additional polyolefins are selected from the group consisting of crystalline ethylene homopolymers and copolymers of ethylene with propylene and/or a C₄-C₁₀ α-olefin. In some embodiments, the additional polyolefins are selected from the group consisting of HDPE, LLDPE and LDPE.

In some embodiments, the additional polyolefins are present in an amount from about 1 to about 10% by weight, alternatively from about 3 to about 7% by weight, based upon the total weight of the polyolefin composition.

In some embodiments, the polyolefin composition (I) is manufactured by mixing the components together, extruding the mixture, and pelletizing the resulting composition.

In some embodiments, gaskets are prepared from the polyolefin composition (I) by a process including the following steps:
a) laying down the polyolefin composition (I) in the molten state on the inner surface of the closure; and
b) forming the laid polyolefin composition (I).

In some embodiments, step a) is carried out by using extruders and metering devices.

In some embodiments, extrusion temperatures applied in step a) are from about 160 to about 220° C.

In some embodiments and before carrying out the step a), the inner surface of the closure is coated with a protective film of a varnish or a lacquer.

In some embodiments, step b) is carried out by compression molding the molten polyolefin composition (I) against the inner surface of the closure.

In some embodiments, the gasket is formed according to a process described in U.S. Pat. No. 5,451,360, incorporated herein by reference.

The resulting gaskets can have different shapes. In some embodiments, the shape is an “o-ring” or a flat film. The flat film can be a variety of thicknesses.

In some embodiments, the composition is free of softening agents. As defined herein, “softening agents” included low molecular weight materials and are easily extractable by contact with free fat/oil components of foods. In some embodiments, the low molecular weight materials are mineral oils.

In some embodiments, the liners can withstand high temperature treatments (sterilization), at temperatures in the range of about 110 to about 125° C.

### EXAMPLES

These Examples are illustrative, and are not intended to limit the scope of this disclosure in any manner whatsoever.

The following analytical methods are used to characterize the polymer compositions.

Thermal Properties (Melting Temperatures and Enthalpies)

Determined by Differential Scanning calorimetry (DSC) on a Perkin Elmer DSC-7 instrument.
The melting temperatures of the butene-1 copolymer A) were determined according to the following method:
TmII (measured in second heating scan): a weighted sample (5-10 mg) obtained from the polymerization was sealed into aluminum pans and heated at 200° C. with a scanning speed corresponding to 10° C./minute. The sample was kept at 200° C. for 5 minutes to allow a complete melting of the crystallites, thereby cancelling the thermal history of the sample. Successively, after cooling to −20° C. with a scanning speed corresponding to 10° C./minute, the peak temperature was taken as crystallization temperature (T_{c}). After standing 5 minutes at −20° C., the sample was heated for the second time at 200° C. with a scanning speed corresponding to 10° C./min. In this second heating run, the peak temperature, when present is taken as the melting temperature of the polybutene-1 (PB) crystalline form II (TmII) and the area as global melting enthalpy (ΔHfII). The butene-1 copolymer component A) of the polyolefin composition (I) did not have a TmII peak.
In order to determine the TmI, the sample was melted, kept at 200° C. for 5 minutes and then cooled down to 20° C. with a cooling rate of 10° C./min.
The sample was then stored for 10 days at room temperature. After 10 days, the sample was subjected to DSC, cooled to −20° C., and then heated at 200° C. with a scanning speed corresponding to 10° C./min. In this heating run, the first peak temperature coming from the lower temperature side in the thermogram was taken as the melting temperature (TmI). The melting temperatures of (i) the propylene homopolymer or copolymer component B) and (ii) the overall composition made from or containing the polymer components A) and B) were measured at the second heating scan under the same conditions as above reported for the determination of TmII of the butene-1 copolymer component A).
Both component B) and the overall composition of the examples show a single melting peak between 130 and 165° C., corresponding to the melting temperature Tₘ.
The area of such melting peak of the overall composition was taken as the melting enthalpy ΔH_{fus} of the polyolefin composition.

Flexural Elastic Modulus

According to norm ISO 178, measured 10 days after molding.

Shore A and D

According to norm ISO 868, measured 10 days after molding.

Tensile Stress and Elongation at Break

According to norm ISO 527 on compression molded plaques, measured 10 days after molding.

Tension Set

According to norm ISO 2285, measured 10 days after molding.

Compression Set

According to norm ISO 815, measured 10 days after molding; MIE

Determined according to norm ISO 1133 with a load of 2.16 kg at 190° C.

MFRL

Determined according to norm ISO 1133 with a load of 2.16 kg at 230° C.

Intrinsic Viscosity

Determined according to norm ASTM D 2857 in tetrahydronaphthalene at 135° C.

Density

Determined according to norm ISO 1183 at 23° C.

Comonomer Contents

Determined by IR spectroscopy or by NMR.

For the butene-1 copolymers, the amount of comonomer was calculated from ¹³C-NMR spectra of the copolymers. Measurements were performed on a polymer solution (8-12 wt %) in dideuterated 1,1,2,2-tetrachloro-ethane at 120° C. The ¹³C NMR spectra were acquired on a Bruker AV-600 spectrometer operating at 150.91 MHz in the Fourier transform mode at 120° C. using a 90° pulse, 15 seconds of delay between pulses and CPD (WALTZ16) to remove ¹H-¹³C coupling. About 1500 transients were stored in 32K data points using a spectral window of 60 ppm (0-60 ppm).

Copolymer Composition

Diad distribution was calculated from ¹³C NMR spectra using the following relations:

PP=100 I₁/Σ

PB=100 I₂/Σ

BB=100 (I₃−I₁₉)/Σ

PE=100 (I₅+I₆)/Σ

BE=100 (I₉+I₁₀)/Σ

EE=100 (0.5(I₁₅+I₆+I₁₀)+0.25(I₁₄))/Σ

Where Σ=I₁+I₂+I₃−I₁₉+I₅+I₆+I₉+I₁₀+0.5(I₁₅+I₆+I₁₀)+0.25(I₁₄)

The molar content was obtained from diads using the following relations:

P(m %)=PP+0.5(PE+PB)

B(m %)=BB+0.5(BE+PB)

E(m %)=EE+0.5(PE+BE)

I₁, I₂, I₃, I₅, I₆, I₉, I₆, I₁₀, I₁₄, I₁₅, I₁₉ are integrals of the peaks in the ¹³C NMR spectrum (peak of EEE sequence at 29.9 ppm as reference). The assignments of these peaks were made according to J. C. Randal, Macromol. Chem Phys., C29, 201 (1989), M. Kakugo, Y. Naito, K. Mizunuma and Tₘ Miyatake, Macromolecules, 15, 1150, (1982), and H. N. Cheng, Journal of Polymer Science, Polymer Physics Edition, 21, 57 (1983), incorporated herein by reference. The data were collected in Table A (nomenclature according to C. J. Carman, R. A. Harrington and C. E. Wilkes, Macromolecules, 10, 536 (1977), incorporated herein by reference).

TABLE A

| I | Chemical Shift (ppm) | Carbon | Sequence |
|---|---|---|---|
| 1 | 47.34-45.60 | S_{αα} | PP |
| 2 | 44.07-42.15 | S_{αα} | PB |
| 3 | 40.10-39.12 | S_{αα} | BB |
| 4 | 39.59 | T_{δδ} | EBE |
| 5 | 38.66-37.66 | S_{αγ} | PEP |
| 6 | 37.66-37.32 | S_{αδ} | PEE |
| 7 | 37.24 | T_{βδ} | BBE |
| 8 | 35.22-34.85 | T_{ββ} | XBX |
| 9 | 34.85-34.49 | S_{αγ} | BBE |
| 10 | 34.49-34.00 | S_{αδ} | BEE |
| 11 | 33.17 | T_{δδ} | EPE |
| 12 | 30.91-30.82 | T_{βδ} | XPE |
| 13 | 30.78-30.62 | S_{γγ} | XEEX |
| 14 | 30.52-30.14 | S_{γδ} | XEEE |
| 15 | 29.87 | S_{δδ} | EEE |
| 16 | 28.76 | T_{ββ} | XPX |
| 17 | 28.28-27.54 | 2B₂ | XBX |
| 18 | 27.54-26.81 | S_{βδ} + 2B₂ | BE, PE, BBE |
| 19 | 26.67 | 2B₂ | EBE |
| 20 | 24.64-24.14 | S_{ββ} | XEX |
| 21 | 21.80-19.50 | CH₃ | P |
| 22 | 11.01-10.79 | CH₃ | B |

For the propylene copolymers the comonomer content was determined by infrared spectroscopy by collecting the IR spectrum of the sample vs. an air background with a Fourier Transform Infrared spectrometer (FTIR). The instrument data acquisition parameters were:
purge time: 30 seconds minimum;
collect time: 3 minutes minimum;
apodization: Happ-Genzel;
resolution: 2 cm⁻¹.

Sample Preparation

Using a hydraulic press, a thick sheet was obtained by pressing about 1 g of sample between two aluminum foils. If homogeneity was uncertain, a minimum of two pressing operations occurred. A small portion was cut from this sheet to mold a film. The film thickness was between 0.02-:0.05 cm (8-20 mils).

Pressing temperature was 180±10° C. (356° F.) and about 10 kg/cm² (142.2 PSI) pressure for about one minute. Then the pressure was released and the sample was removed from the press and cooled the to room temperature.

The spectrum of a pressed film of the polymer was recorded in absorbance vs. wavenumbers (cm⁻¹). The following measurements were used to calculate ethylene and butene-1 content:
Area (At) of the combination absorption bands between 4482 and 3950 cm ⁻¹ which was used for spectrometric normalization of film thickness.
If ethylene was present, Area (AC2) of the absorption band between 750-700 cm⁻¹ after two proper consecutive spectroscopic subtractions of an isotactic non additivated polypropylene spectrum was measured and then, if butene-1 was present, a reference spectrum of a butene-1-propylene random copolymer in the range 800-690 cm⁻¹ was used.
If butene-1 was present, Height (DC4) of the absorption band at 769 cm⁻¹ (maximum value), after two proper consecutive spectroscopic subtractions of an isotactic non additivated polypropylene spectrum was measured and then, if ethylene is present, a reference spectrum of an ethylene-propylene random copolymer in the range 800-690 cm⁻¹ was used.
   To calculate the ethylene and butene-1 content, calibration straight lines for ethylene and butene-1 were obtained by using reference samples of ethylene and butene-1.

Mw/Mn determination by GPC

The determination of the means Mn and Mw, and Mw/Mn derived therefrom was carried out using a Waters GPCV 2000 apparatus, which was equipped with a column set of four PLgel Olexis mixed-gel (Polymer Laboratories) and an IR4 infrared detector (PolymerChar). The dimensions of the columns were 300×7.5 mm and their particle size was 13 μm. The mobile phase used was 1-2-4-trichlorobenzene (TCB) and its flow rate was kept at 1.0 ml/min. The measurements were carried out at 150° C. Solution concentrations were 0.1 g/dl in TCB and 0.1 g/1 of 2,6-diterbuthyl-p-chresole were added to prevent degradation. For GPC calculation, a universal calibration curve was obtained using 10 polystyrene (PS) standard samples supplied by Polymer Laboratories (peak molecular weights ranging from 580 to 8500000). A third order polynomial fit was used to interpolate the experimental data and obtain the relevant calibration curve. Data acquisition and processing were done using Empower (Waters). The Mark-Houwink relationship was used to determine the molecular weight distribution and the relevant average molecular weights: the K values were K_{PS}=1.21×10⁻⁴ dL/g and K_{PB}=1.78×10⁻⁴ dL/g for PS and PB respectively, while the Mark-Houwink exponents α=0.706 for PS and α=0.725 for PB were used.

For butene-1/ethylene copolymers, it was assumed that the composition was constant in the whole range of molecular weight and the K value of the Mark-Houwink relationship was calculated using a linear combination as reported below:

K_{EB}=x_{E}K_{PE}+x_{P}K_{PB}

where K_{EB} was the constant of the copolymer, K_{PE} (4.06×10⁻⁴, dL/g) and K_{PB} (1.78×10⁻⁴ dl/g) were the constants of polyethylene and polybutene, x_{E}and x_{B} were the ethylene and the butene-1 weight % content. The Mark-Houwink exponents α=0.725 was used for all the butene-1/ethylene copolymers.

Fractions Soluble and Insoluble in Xylene at 0° C. (XS-0° C.)

2.5 g of the polymer sample were dissolved in 250 ml of xylene at 135° C. under agitation. After 30 minutes, the solution was allowed to cool to 100° C., still under agitation, and then placed in a water and ice bath to cool down to 0° C. Then, the solution was allowed to settle for 1 hour in the water and ice bath. The precipitate was filtered with filter paper. During the filtering, the flask was left in the water and ice bath to keep the flask inner temperature as near to 0° C. as possible. Once the filtering was finished, the filtrate temperature was balanced at 25° C., dipping the volumetric flask in a water-flowing bath for about 30 minutes and then, divided in two 50 ml aliquots. The solution aliquots were evaporated in nitrogen flow, and the residue dried under vacuum at 80° C. until constant weight was reached. If the weight difference between the two residues was not less than 3%, the test was repeated. The percent by weight of polymer soluble (Xylene Solubles at 0° C.=XS 0° C.) was calculated from the average weight of the residues. The insoluble fraction in o-xylene at 0° C. (xylene Insolubles at 0° C.=XI % 0° C.) was:

XI % 0° C.=100−XS % 0° C.

Fractions Soluble and Insoluble in Xylene at 25° C. (XS-25° C.)

2.5 g of polymer were dissolved in 250 ml of xylene at 135° C. under agitation. After 20 minutes, the solution was allowed to cool to 25° C., still under agitation, and then allowed to settle for 30 minutes. The precipitate was filtered with filter paper, the solution was evaporated in nitrogen flow, and the residue was dried under vacuum at 80° C. until constant weight was reached. The percent by weight of polymer soluble (Xylene Solubles—XS) and insoluble at room temperature (25° C.) were calculated.

As used herein, the percent by weight of polymer insoluble in xylene at room temperature (25° C.) was considered the isotactic index of the polymer. It is believed that this measurement corresponds to the isotactic index determined by extraction with boiling n-heptane, which constitutes the isotactic index of polypropylene polymers as the term is used herein.

Determination of Isotactic Pentads Content

50 mg of each sample were dissolved in 0.5 ml of C₂D₂Cl₄.

The ¹³C NMR spectra were acquired on a Bruker DPX-400 (100.61 Mhz, 90° pulse, 12 s delay between pulses). About 3000 transients were stored for each spectrum; the mmmm pentad peak (27.73 ppm) was used as reference.

The microstructure analysis was carried out as described in literature (Macromolecules 1991, 24, 2334-2340, by Asakura Tₘ et Al. . and Polymer, 1994, 35, 339, by Chujo R. et Al., incorporated herein by reference).

The percentage value of pentad tacticity (mmmm%) for butene-1 copolymers was the percentage of stereoregular pentads (isotactic pentad) as calculated from the relevant pentad signals (peak areas) in the NMR region of branched methylene carbons (around 27.73 ppm assigned to the BBBBB isotactic sequence), with due consideration of the superposition between stereoirregular pentads and of those signals, falling in the same region, due to the comonomer.

Determination of X-Ray Crystallinity

The X-ray crystallinity was measured with an X-ray Diffraction Powder Diffractometer using the Cu-Kal radiation with fixed slits and collecting spectra between diffraction angle 2Θ=5° and 2Θ=35° with step of 0.1° every 6 seconds.

Measurements were performed on compression molded specimens in the form of disks of about 1.5-2.5 mm of thickness and 2.5-4.0 cm of diameter. These specimens were obtained in a compression molding press at a temperature of 200° C.±5° C. without applying pressure for 10 minutes, then applying a pressure of about 10 Kg/cm² for a few seconds and repeating the last operation for 3 times.

The diffraction pattern was used to derive the components for the degree of crystallinity by defining a linear baseline for the whole spectrum and calculating the total area (Ta), expressed in counts/sec·2Θ, between the spectrum profile and the baseline. Then an amorphous profile was defined, along the whole spectrum, that separate, according to the two phase model, the amorphous regions from the crystalline ones. The amorphous area (Aa), expressed in counts/sec·2Θ, was calculated as the area between the amorphous profile and the baseline; and the crystalline area (Ca), expressed in counts/sec·2Θ, was calculated as Ca=Ta−Aa. The degree of crystallinity of the sample was then calculated according to the formula:

% Cr=100×Ca/Ta

### Examples 1-3 and Comparative Examples 1 and 2

Materials Used in the Examples
PB-1: butene-1/ethylene copolymer containing 16% by moles of copolymerized ethylene, was prepared according to the process disclosed in Patent Cooperation Treaty Publication No. WO2009000637, incorporated herein by reference, and in-line blended with a propylene copolymer composition (I) added in amount of 7% by weight with respect to the total weight of the butene-1/ethylene copolymer and the propylene copolymer composition (i).
   Such propylene copolymer composition (i) had MFRL of 5.5 g/10 min., total copolymerized ethylene content of 3% by weight, total copolymerized butene-1 content of 6% by weight; XS-25° C. of 19% by weight and Tₘ of 133° C., and was made of the following two components:
   i′) 35% by weight of a copolymer of propylene with ethylene (3.2% by weight in the copolymer), and
   i″) 65% by weight of a copolymer of propylene with ethylene (3.2% by weight in the copolymer) and butene-1 (6% by weight in the copolymer); wherein the amounts of i′) and i″) were referred to the total weight of i′)+i″);
PP: copolymer of propylene with ethylene, containing 6% by weight of ethylene, based upon the total weight of the copolymer, having Tₘ of 133° C., MFRL of about 7 g/10 min., XS-25° C. of 20% by weight;
Stabilizers: blend of 0.05% by weight of pentaerythritol tetrakis(3-(3,5-di-tert-butyl-4-hydroxyphenyl)propionate (Irganox® 1010, sold by BASF) and 0.05% by weight of tris (2.4-di-tert-butylphenyl) phosphite (Irgafos® 168, sold by BASF), the percent amounts being referred to the total weight of the polyolefin composition;
Lubricants: blend of 1% by weight of erucamide (Crodamide® ER, sold by Croda), 1% by weight of Oleamide (Crodamide® OR, sold by Croda) and 1% by weight of Glyceryl Stearate (Atmer® 129, sold by Croda), the percent amounts being referred to the total weight of the polyolefin composition;
Pigment: Titanium dioxide Ti-Pure® R-104, sold by DuPont.

No melting peak was detected in the DSC analysis (second scan) of the above described PB-1.

The materials were melt-blended in a co-rotating twin screw extruder Coperion ZSK40SC, with screw diameter of 40 mm and screw length/diameter ratio of 43:1, under the following conditions:
extrusion temperature of 180-200° C.;
screw rotation speed of 220 rpm;
production rate of 60 kg/hour.

The properties of the final compositions are reported in Table 1.

In Table 1 are also reported the properties of the above described PP and PB-1 components (Comparison Examples 1 and 2).

TABLE I

| | | Example | | | | |
|---|---|---|---|---|---|---|
| | | 1 | 2 | 3 | Comp. 1 | Comp. 2 |
| PB-1 | Weight % | 57.95 | 48.3 | 37 | — | 100 |
| PP | Weight % | 38.65 | 48.3 | 59.6 | 100 | — |
| Stabilizers | Weight % | 0.1 | 0.1 | 0.1 | — | — |
| Lubricants | Weight % | 3.0 | 3.0 | 3.0 | — | — |
| Pigment | Weight % | 0.3 | 0.3 | 0.3 | — | — |
| Amount of A)* | Weight % | 55.8 | 46.5 | 35.6 | 0 | 93 |
| Amount of B)* | Weight % | 44.2 | 53.5 | 64.4 | 100 | 7 |
| Composition Properties | | | | | | |
| Δ H_{fus} | J/g | 34.45 | 40.47 | 48.23 | 71 | 0 |
| Tₘ | ° C. | 132.6 | 132.8 | 131.8 | 133 | — |
| Shore A | | 91 | 91 | 91 | — | 60 |
| Shore D | | 25.5 | 29.6 | 37.7 | 58 | <20 |
| MIE | gr/10′ | 3.94 | 3.84 | 4.14 | — | 1.4 |
| Stress at Break | MPa | 17 | 19.9 | 21.1 | — | 11 |
| Elongation at Break | % | 1090 | 1150 | 1040 | — | 790 |
| Compression Set 22 hours | % | 52 | 51 | 51 | — | 32 |
| 23° C. after 10 min. in | | | | | | |
| Autoclave | | | | | | |
| Compression Set 22 hours | % | 71 | 69 | 70 | — | 100 |
| 70° C. after 10 min. in | | | | | | |
| Autoclave | | | | | | |
| Compression Set 22 hours | % | 90 | — | 88 | — | 100 |
| 100° C. after 10 min. in | | | | | | |
| Autoclave | | | | | | |

Note:
*weight % with respect to the total weight of A) + B).

What is claimed is:

1. A gasket for closures comprising:
(I) a polyolefin composition (I) comprising
A) from about 25 to about 62% by weight, based upon the total weight of the polyolefin composition, of a copolymer of butene-1 with ethylene having a copolymerized ethylene content of up to about 18% by mole, based upon the molar composition of the copolymer, and without a melting peak detectable at the DSC at the second heating scan and
B) from about 38 to about 75% by weight, based upon the total weight of the polyolefin composition, of (i) a propylene homopolymer, or (ii) a propylene copolymer, or (iii) a mixture of two or more of (i) and (ii), having a melting temperature Tₘ, measured by DSC at the second heating scan, of from about 130° C. to about 165° C.
wherein the amounts of A) and B) are referred to the total weight of A)+B) and the DSC second heating scan is carried out with a heating rate of 10° C. per minute.

2. The gasket of claim 1, wherein the polyolefin composition (I) has a MIE value of from about 0.5 to about 8 g/10 min., where MIE is the melt flow index at 190° C. with a load of 2.16 kg, determined according to ISO 1133.

3. The gasket of claim 1, wherein the polyolefin composition (I) has a ΔH_{fus} value of-from about 30 to about 55 J/g.

4. The gasket of claim 1, wherein the butene-1 copolymer component A) has Shore A equal to or lower than about 80.

5. The gasket of claim 1, wherein the butene-1 copolymer component A) has a Mw/Mn value of equal to or lower than about 3.

6. The gasket of claim 1, wherein the butene-1 copolymer component A) has at least one of the following additional features:
MIE of from about 0.5 to about 3 g/10 min.;
a lower limit of the copolymerized ethylene content of about 12% by mole, based upon the molar composition of the copolymer;
a Shore A value equal to or lower than about 80;
a Shore D value equal to or lower than about 20;
a Mw/Mn value, where Mw is the weight average molar mass and Mn is the number average molar mass, both measured by GPC, equal to or lower than about 3;
a tension set of less than about 30% at 100% of deformation at 23° C. (ISO 2285);
a percentage of butene-1 units in form of isotactic pentads (mmmm%) greater than about 80%
tensile stress at break, measured according to ISO 527, of from about 3 MPa to about 20 MPa;
tensile elongation at break, measured according to ISO 527, of from about 550% to about 1000%;
intrinsic viscosity (I.V.) equal to or higher than about 1 dl/g;
crystallinity of less than about 30% measured via X-ray;
density of about 0.895 g/cm³ or less; and
content of xylene insoluble fraction at 0° C. of less than about 15% by weight, based upon the total weight of the butene-1 copolymer.

7. The gasket of claim 1, wherein the propylene homopolymer or copolymer component B) has MFRL values of from about 0.5 to about 9 g/10 min, where MFRL is the melt flow rate at 230° C. with a load of 2.6 kg, determined according to ISO 1133.

8. A twist closure comprising:
(a) a gasket for closures comprising
(I) a polyolefin composition (I) comprising
A) from about 25 to about 62% by weight, based upon the total weight of the polyolefin composition, of a copolymer of butene-1 with ethylene having a copolymerized ethylene content of up to about 18% by mole, based upon the molar composition of the copolymer, and without a melting peak detectable at the DSC at the second heating scan and
B) from about 38 to about 75% by weight, based upon the total weight of the polyolefin composition, of (i) a propylene homopolymer, or (ii) a propylene copolymer, or (iii) a mixture of two or more of (i) and (ii), having a melting temperature Tₘ, measured by DSC at the second heating scan, of from about 130° C. to about 165° C.;
wherein the amounts of A) and B) are referred to the total weight of A)+B) and the DSC second heating scan is carried out with a heating rate of 10° C. per minute.

9. The twist closure of claim 8, wherein the twist closure is for food containers.

10. The twist closure of claim 9, wherein the twist closure is in the form of a cap.

11. A process for preparing a gasket comprising the following steps:
a) laying down a polyolefin composition (I) in a molten state on the inner surface of a closure having an inner surface and an outer surface;
b) forming the laid polyolefin composition (I),
wherein the gasket comprises
(I) the polyolefin composition (I) comprising
A) from about 25 to about 62% by weight, based upon the total weight of the polyolefin composition, of a copolymer of butene-1 with ethylene having a copolymerized ethylene content of up to about 18% by mole, based upon the molar composition of the copolymer, and without a melting peak detectable at the DSC at the second heating scan and
B) from about 38 to about 75% by weight, based upon the total weight of the polyolefin composition, of (i) a propylene homopolymer, or (ii) a propylene copolymer, or (iii) a mixture of two or more of (i) and (ii), having a melting temperature Tₘ, measured by DSC at the second heating scan, of from about 130° C. to about 165° C.;
wherein the amounts of A) and B) are referred to the total weight of A)+B) and the DSC second heating scan is carried out with a heating rate of 10° C. per minute.
